(19) United States
(12) Patent Application Publication
(10) Pub. No.: US 2019/0334465 A1
(43) Pub. Date: Oct. 31, 2019

(54) MOTOR DRIVE UNIT

(71) Applicants: Nidec Corporation, Kyoto (JP); Nidec Elesys Corporation, Kawasaki-shi (JP)

(72) Inventors: Yuhi NAKADA, Kyoto (JP); Takashi KOIKEGAMI, Kawasaki-shi (JP); Isao SAMBOMMATSU, Kawasaki-shi (JP); Koji MUKAIYAMA, Kawasaki-shi (JP)

(21) Appl. No.: 16/393,026

(22) Filed: Apr. 24, 2019

(30) Foreign Application Priority Data
Apr. 25, 2018 (JP) 2018-084111

(51) Int. Cl. H02P 21/20; H02P 21/16; H02P 21/18; H02P 21/22; H02P 27/12

(52) U.S. Cl. CPC H02P 21/20; H02P 21/16; H02P 27/12; H02P 21/22; H02P 21/18

(57) ABSTRACT

A motor drive includes limiting circuitry that controls a motor based on an instruction torque, and calculates a limitation rate that limits the instruction torque. The instruction torque is limited based on the limitation rate calculated by the limiting circuitry. The motor drive also includes a controller that outputs electric power to drive the motor based on the limited instruction torque.

### CROSS REFERENCE TO RELATED APPLICATION

The present invention claims priority under 35 U.S.C. § 119 to Japanese Application No. 2018-084111 filed on Apr. 25, 2018 the entire contents of which is incorporated herein by reference.

### 1. FIELD OF THE INVENTION

The present disclosure relates to a motor drive unit.

### 2. BACKGROUND

In a conventional electric vehicle or the like, a driving torque of a motor as the drive source is controlled. A method of controlling the driving torque has been known in which a current controller restricts current to protect an inverter, a motor, and the vehicle from overvoltage, overcurrent, and temperature rise, for example.

However, in a main driving motor of the vehicle, the vehicle is controlled according to the driving torque. Hence, the aforementioned current control by the current controller hinders determination of the actual torque amount of the vehicle, and may inhibit torque control based on the actual torque amount.

In view of the above problem, a motor controller disclosed as a conventional technique includes: a torque upper limit calculation processor that calculates a torque upper limit of the motor according to the rotational speed of the motor; and a torque instruction value liming portion that limits the torque instruction based on the torque upper limit, and calculates a motor driving torque instruction value based on the limited torque instruction.

However, in the conventional motor controller, since the torque upper limit is acquired from a table, the torque can be limited only by a fixed value that is set according to the rotational speed of the motor. For example, when the motor needs to be controlled to have low speed and high torque, such as when continuously traveling uphill or downhill for a certain period, when driving onto a step, or when maintaining a stopped state, the torque requires limitation that cannot be set by use of the table. Hence, the motor has to be stopped.

### SUMMARY

An example embodiment of a motor controller of the present disclosure is a motor drive that controls a motor based on an instruction torque. The motor drive includes limiting circuitry that calculates a limitation rate that limits the instruction torque. The instruction torque is limited based on the limitation rate calculated by the limiting circuitry. The motor drive also includes a controller that outputs electric power that drives the motor based on the limited instruction torque.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram showing a schematic configuration of a motor drive system of an example embodiment of the present disclosure.

FIG. 2 is a functional block diagram of a rotational speed calculator.

FIG. 3 is a functional block diagram of a limiting portion.

FIG. 4 is a diagram showing a function used to calculate a limitation rate of a DC current.

FIG. 5 is a diagram showing a function used to calculate a limitation rate of a power supply voltage.

FIG. 6 is a diagram showing a function used to calculate a limitation rate of a phase current.

FIG. 7 is a flowchart showing an exemplar operation of a motor drive unit for calculating a limitation rate.

### DETAILED DESCRIPTION

Hereinafter, example embodiments of the present disclosure will be described in detail with reference to the accompanying drawings. Note that the dimensional ratio in the drawings is expanded for the sake of simple description, and may differ from the actual ratio.

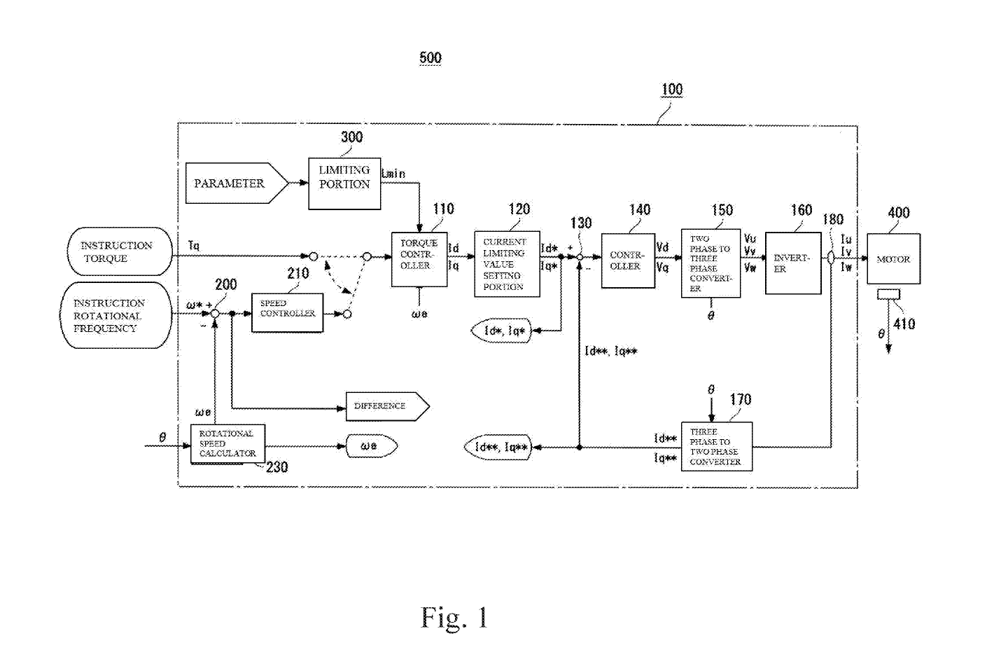

FIG. 1 shows an example of a schematic configuration of a motor drive system 500 of an example embodiment of the present disclosure. As shown in FIG. 1, the motor drive system 500 includes a motor drive unit 100, a motor 400, and an angle sensor 410.

The motor drive unit 100 includes a torque controller 110, a current limiting value setting portion 120, an adder 130, a controller 140, a two phase to three phase converter 150, an inverter 160, a three phase to two phase converter 170, a current sensor 180, and a limiting portion 300. Note that the torque controller 110, the current limiting value setting portion 120, and the like are an example of a controller. The motor drive unit 100 is preferably provided as hardware or a combination of hardware and software. Each of the current limiting value setting portion 120, the adder 130, the controller 140, the two phase to three phase converter 150, the inverter 160, the three phase to two phase converter 170, the current sensor 180, and the limiting portion 300 are preferably provided by circuitry. Alternatively, the functions of the current limiting value setting portion 120, the adder 130, the controller 140, the two phase to three phase converter 150, the inverter 160, the three phase to two phase converter 170, the current sensor 180, and/or the limiting portion 300 could be reproduced using software or a combination of hardware and software.

An unillustrated vehicle controller switches to torque control when the vehicle accelerates. The torque controller 110 receives input of an instruction torque (torque instruction value) Tq from the vehicle controller by controller area network (CAN) communication, other communication, or hard wire (wire communication).

The torque controller 110 calculates a target torque for controlling the rotational frequency of the motor 400 by multiplying the instruction torque Tq by a limitation rate Lmin from the limiting portion 300, and calculates each of a d-axis current instruction value Id and a q-axis current instruction value Iq based on the calculated target torque. The calculated d-axis current instruction value Id and q-axis current instruction value Iq are output to the current limiting value setting portion 120. For example, if the limitation rate Lmin from the limiting portion 300 is 0%, the target torque is also 0 Nm, and the current instruction value is also set to 0 A.

The current limiting value setting portion 120 sets a d-axis current instruction value Id* and q-axis current instruction value Iq* as upper limits based on the d-axis current instruction value Id and q-axis current instruction value Iq supplied from the torque controller 110. The d-axis current instruction value Id* and q-axis current instruction value Iq* are output to the adder 130, and are also output to the limiting portion 300 as parameters used to calculate a limitation rate L5.

The three phase to two phase converter 170 performs dq transformation on phase currents Iu, Iv, Iw detected by the current sensor 180 based on an angle signal θ (electrical angle) feedback from the angle sensor 410, and calculates a d-axis current value Id** and a q-axis current value Iq**. The converted d-axis current value Id** and q-axis current value Iq** are output to the adder 130, and are also output to the limiting portion 300 as parameters used to calculate the limitation rate L5.

The adder 130 calculates a difference between the d-axis current instruction value Id* from the current limiting value setting portion 120 and the d-axis current value Id** from the three phase to two phase converter 170. The calculated difference is output to the controller 140. Similarly, the adder 130 calculates a difference between the q-axis current instruction value Iq* from the current limiting value setting portion 120 and the q-axis current value Iq** from the three phase to two phase converter 170. The calculated differences are output to the controller 140.

The controller 140 computes voltage instruction values Vd, Vq by performing proportional plus integral (PI) control computation, for example, such that the differences from the adder 130 converge to zero. The computed voltage instruction values Vd, Vq are output to the two phase to three phase converter 150.

The two phase to three phase converter 150 performs inverse dq transformation to transform the two phase voltage instruction values Vd, Vq into three phase voltage instruction values Vu, Vv, Vw of a u-phase, v-phase, and w-phase, based on an angle signal θ (electrical angle) feedback from the angle sensor 410. The three phase voltage instruction values Vu, Vv, Vw obtained by the inverse dq transformation are output to the inverter 160.

The inverter 160 has six bridge-connected switching elements. An insulated gate bipolar transistor (IGBT) may be used as the switching element, for example. The inverter 160 drives the switching element according to the three-phase PWM signal of a duty based on the three phase voltage instruction values Vu, Vw from the two phase to three phase converter 150, and thereby applies a voltage equivalent to the three phase voltage instruction values Vu, Vv, Vw to the motor 400. In the example embodiment, each switching element has a temperature sensor (not shown) for detecting a temperature T2 of the switching element. Additionally, a substrate on which the inverter 160 and other components are mounted has a temperature sensor (not shown) for detecting a temperature T3 of the substrate. Note that since the configuration of the above-mentioned three phase inverter circuit and the like is a known technique, detailed description is omitted.

The current sensor 180 detects the phase currents Iu, Iv, Iw supplied to the phases of the motor 400 from the inverter 160. The detected three phase currents Iu, Iv, Iw are output to the three phase to two phase converter 170.

The motor 400 is configured of a three-phase brushless motor, for example, and rotates by being driven by the inverter 160. In the example embodiment, the motor 400 has two temperature sensors (not shown), for example, for detecting a temperature T1 of the motor 400. Note that the number of temperature sensors is not limited to two.

The angle sensor 410 detects the angle signal θ according to a change in angle of the rotation axis of the motor 400. The detected angle signal θ is output to the two phase to three phase converter 150, the three phase to two phase converter 170, and a rotational speed calculator 230, for example. Note that a known angle detector such as a resolver or an MR sensor may be used as the angle sensor 410, for example.

The limiting portion 300 calculates the minimum limitation rate Lmin (output gain) based on limitation rates of multiple parameters such as the input phase currents Iu, Iv, Iw, a DC current I, and the temperature T1 of the motor 400. The limitation rate Lmin is a limiting value for limiting the instruction torque Tq to an optimal state depending on the traveling state of the vehicle. For example, if the limitation rate is 100%, the instruction torque Tq is set as the target torque, and the limitation is set such that the lower the limitation rate, the smaller the target torque. According to the example embodiment, since the instruction torque is limited by the limitation rate Lmin calculated by the limiting portion 300, even when the torque requires limitation that cannot be set by use of the conventional table storing torque upper limits, for example, the torque can be limited optimally.

The motor drive unit 100 also includes an adder 200, a speed controller 210, and the rotational speed calculator 230.

The unillustrated vehicle controller switches to rotational frequency control when the vehicle travels at low speed. The adder 200 receives input of an instruction rotational frequency ω* from the vehicle controller by CAN communication, other communication, or hard wire (wire communication). The adder 200 adds the input instruction rotational frequency ω* and a motor rotational speed ωe from the rotational speed calculator 230. The speed controller 210 controls speed based on information such as rotational frequency from the adder 200.

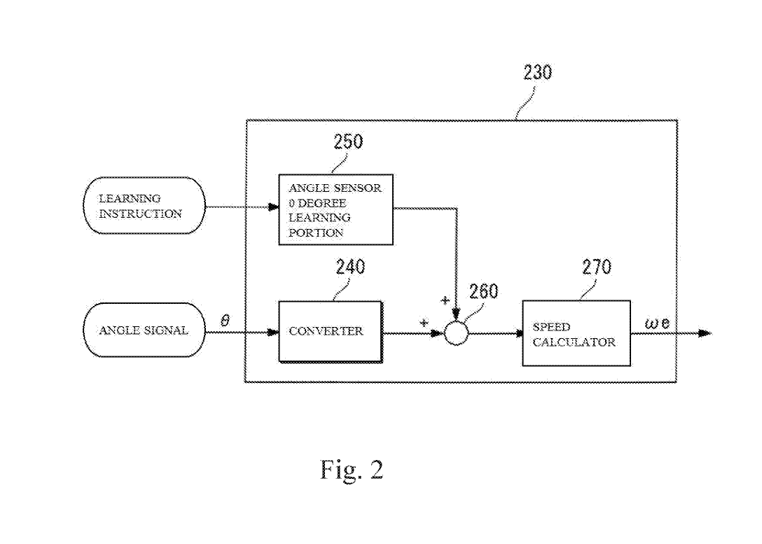

FIG. 2 shows an example of functional blocks of the rotational speed calculator 230. As shown in FIG. 2, the rotational speed calculator 230 has a converter 240, an angle sensor 0 degree learning portion 250, an adder 260, and a speed calculator 270.

The converter 240 converts the analogue angle signal θ from the angle sensor 410 into digital data. Note that software having a conversion function or a device such as an R/D converter may be adopted as the converter 240. The angle sensor 0 degree learning portion 250 calculates a zero point from the angle of the motor 400 based on an input learning instruction. The adder 260 adjusts angle displacement between the motor 400 and the angle sensor 410, based on the angle signal θ from the converter 240 and zero-point information from the angle sensor 0 degree learning portion 250. The speed calculator 270 calculates the motor rotational speed ωe based on an electrical angle θe of the motor 400, for example. The calculated motor rotational speed ωe is output to the limiting portion 300 as a parameter used to calculate a limitation rate L4.

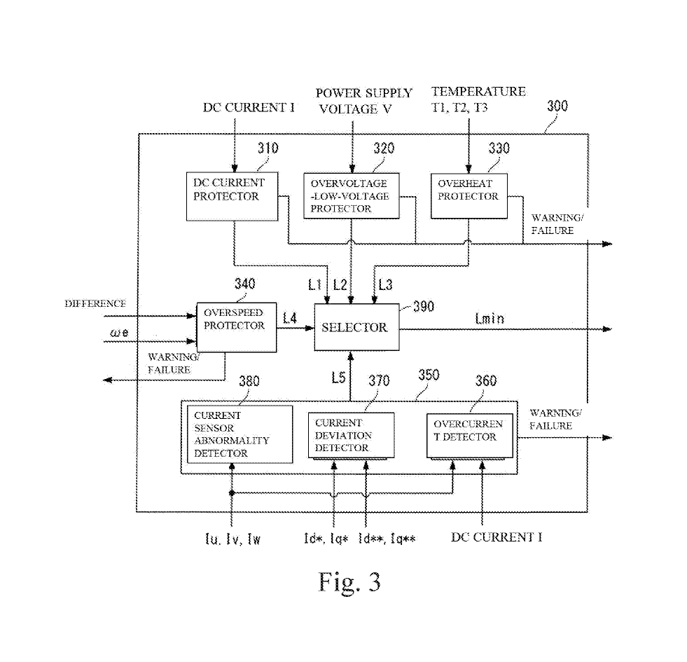

FIG. 3 is a functional block diagram of the limiting portion 300. As shown in FIG. 3, the limiting portion 300 includes a DC current protector 310, an overvoltage-low-voltage protector 320, an overheat protector 330, an overspeed protector 340, a phase current protector 350, and a selector 390.

The DC current protector 310 acquires a DC current I of a power source such as a battery, for example. The cycle of acquiring the DC current I is 1 ms, for example. The DC current protector 310 calculates a limitation rate L1 of the acquired DC current I by use of a function graph for calculating the limitation rate L1. In addition, if the DC current protector 310 determines that the DC current I is abnormal after calculating the limitation rate L1, the DC current protector 310 notifies the user of warning and failure information. In the example embodiment, the notification may be made by sound, or by characters, image or the like displayed on a screen of a display, for example.

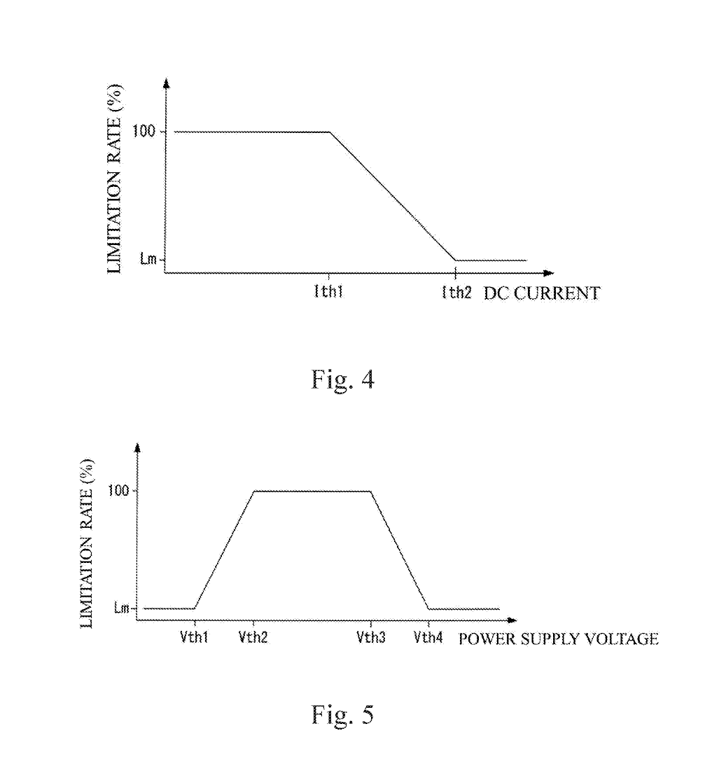

FIG. 4 shows a function graph used to calculate the limitation rate L1 of the DC current I. Note that in FIG. 4, the vertical axis represents the limitation rate and the horizontal axis represents the DC current. As shown in FIG. 4 if the DC current I is lower than a threshold Ith1, the DC current protector 310 determines that the DC current I is normal, and sets the limitation rate L1 to 100%. If the DC current I is equal to or higher than the threshold Ith1 (limitation start value) and equal to or lower than a threshold Ith2 (limitation end value), the DC current protector 310 determines that the DC current I is abnormal, and sets the limitation rate L1 to a value higher than the minimum Lm and lower than 100%. For example, the limitation rate L1 is set so as to gradually decrease with a constant gradient, along with an increase in the DC current I. If the DC current I is higher than Ith2, the DC current protector 310 determines that the abnormality level of the DC current I is particularly high, and sets the limitation rate L1 to the minimum Lm. The calculated limitation rate L1 is output to the selector 390.

To calculate linear interpolation on the graph shown in FIG. 4, the following equation (1) may be used, for example. For example, if the DC current I input as a parameter is equal to or higher than the threshold Ith1 and equal to or lower than the threshold Ith2, the DC current protector 310 acquires the limitation rate L1 by performing real-time calculation by use of the equation (1). Note that the program of the equation (1) and coefficients such as x₀ in the equation (1) may be pre-stored in an unillustrated memory.

$$\begin{matrix}[ Expression 1 ] & \\ y = {y}_{0} + ( {y}_{1} - {y}_{0} ) \frac{x - {x}_{0}}{{x}_{1} - {x}_{0}} & ( 1 )\end{matrix}$$

Where x represents the current DC current I, x₀ represents a value that starts limitation of the DC current I, x₁ represents a value that ends the limitation of the DC current I, y represents the limitation rate, y₀ represents the minimum limitation rate L1, and y₁ represents the maximum limitation rate L1.

Referring back to FIG. 3, the overvoltage-low-voltage protector 320 acquires a power supply voltage V of a power source such as a battery, for example. The cycle of acquiring the power supply voltage V is 1 ms, for example. The overvoltage-low-voltage protector 320 calculates a limitation rate L2 of the acquired power supply voltage V by use of a function graph (aforementioned equation (1)) for calculating the limitation rate L2. In addition, if the overvoltage-low-voltage protector 320 determines that the power supply voltage V is abnormal after calculating the limitation rate L2, the overvoltage-low-voltage protector 320 notifies the user of warning and failure information.

FIG. 5 shows a function graph used to calculate the limitation rate L2 of the power supply voltage V. Note that in FIG. 5, the vertical axis represents the limitation rate and the horizontal axis represents the power supply voltage. As shown in FIG. 5, if the power supply voltage V is higher than a threshold Vth2 and lower than a threshold Vth3, the overvoltage-low-voltage protector 320 determines that the power supply voltage V is normal, and sets the limitation rate L2 to 100%. If the power supply voltage V is equal to or higher than a threshold Vth1 and equal to or lower than the threshold Vth2, the overvoltage-low-voltage protector 320 determines that the power supply voltage V is abnormal (low voltage), and sets the limitation rate L2 to a value higher than the minimum Lm and lower than 100%. Similarly, if the power supply voltage V is lower than the threshold Vth1, too, the overvoltage-low-voltage protector 320 determines that the power supply voltage V is particularly low (low voltage), and sets the limitation rate L2 to the minimum Lm. If the power supply voltage V is equal to or higher than the threshold Vth3 and equal to or lower than a threshold Vth4, the overvoltage-low-voltage protector 320 determines that the power supply voltage V is abnormal (overvoltage), and sets the limitation rate L2 to a value higher than the minimum Lm and lower than 100%. Similarly, if the power supply voltage V is higher than the threshold Vth4, too, the overvoltage-low-voltage protector 320 determines that the power supply voltage V is particularly high (overvoltage), and sets the limitation rate L2 to the minimum Lm. For example, if the power supply voltage V input as a parameter is equal to or higher than the threshold Vth1 and equal to or lower than the threshold Vth2, the overvoltage-low-voltage protector 320 acquires the limitation rate L2 by performing real-time calculation by use of the aforementioned equation (1). The calculated limitation rate L2 is output to the selector 390.

Referring back to FIG. 3, the overheat protector 330 acquires the temperature T1 of two points of the motor 400, the temperature T2 of the six switching elements forming the inverter 160, and the temperature T3 of the substrate on which the switching elements and other components are mounted. The cycle of acquiring the temperatures T1 to T3 is 1 ms, for example. The overheat protector 330 calculates a limitation rate L3 of the temperatures T1 to T3, too, by using the same linear pattern function graph (aforementioned equation (1)) as in FIG. 4. If any of the temperatures T1 to T3 is equal to or higher than a threshold Tth, the overheat protector 330 determines that the temperature is rising excessively, and sets the limitation rate L3 to a value equal to or higher than the minimum Lm and lower than 100%. The calculated limitation rate L3 is output to the selector 390. If it is determined that the acquired temperatures T1 to T3 are abnormal, the overheat protector 330 notifies the user of warning and failure information.

The phase current protector 350 has an overcurrent detector 360, a current deviation detector 370, and a current sensor abnormality detector 380.

The overcurrent detector 360 acquires the phase currents Iu, Iv, Iw detected by the current sensor 180, and also acquires the DC current I of the power source. The cycle of acquiring the phase currents Iu, Iv, Iw, and the like is 1 ms, for example. The overcurrent detector 360 calculates a limitation rate L5a of the acquired phase currents Iu, Iv, Iw by using a function graph for calculating the limitation rate L5a. Similarly, the overcurrent detector 360 calculates a limitation rate L5b of the acquired DC current I of the power source by using a function graph for calculating the limitation rate L5b. Hereinbelow, a description will be given of a case of calculating the limitation rate L5a of the phase currents Iu, Iv, Iw.

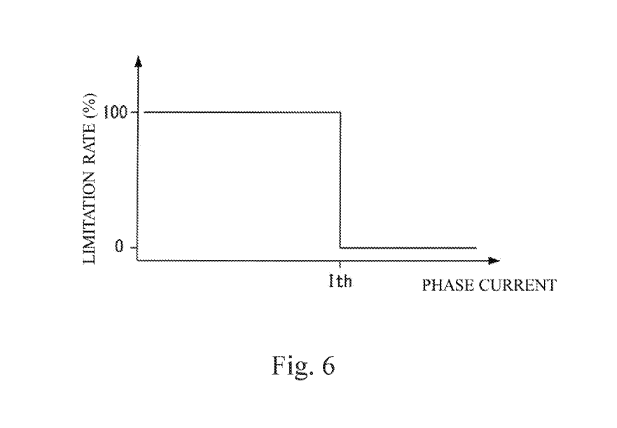

FIG. 6 shows a function graph used to calculate the limitation rate L5a of the phase currents Iu, Iv, Iw. Note that in FIG. 6, the vertical axis represents the limitation rate and the horizontal axis represents the phase current. As shown in FIG. 6, if the sum of the phase currents Iu, Iv, Iw is a threshold Ith (0[A]), for example, the overcurrent detector 360 determines that the current value is normal, and sets the limitation rate L5a to 100%. If the sum of the phase currents Iu, Iv, Iw is not the threshold Ith, the overcurrent detector 360 determines that the current value is abnormal, and sets the limitation rate L5a to 0%. This is because output of the motor 400 needs to be stopped immediately when overcurrent occurs. The calculated limitation rate L5a is output to the selector 390.

The overcurrent detector 360 calculates the limitation rate L5b of the DC current I of the power source, too, by using the same linear pattern function graph as in FIG. 6. If the DC current I is higher than the threshold Ith, the overcurrent detector 360 determines that an overcurrent occurs and output of the motor 400 needs to be stopped immediately, and therefore sets the limitation rate L5b to 0%.

Referring back to FIG. 3, the current deviation detector 370 acquires the d-axis current value Id** and q-axis current value Iq** obtained by performing dq transformation on the phase currents Iu, Iv, Iw by the angle signal θ and the d-axis current instruction value Id* and q-axis current instruction value Iq* from the current limiting value setting portion 120 which are target values, and calculates the deviation between the values. The cycle of acquiring the current instruction values is 1 ms, for example. The current deviation detector 370 calculates a limitation rate L5c of the calculated deviation, too, by using the same linear pattern function graph as in FIG. 6. If the deviation is larger than a threshold Th, the current deviation detector 370 determines that an abnormality occurs in the phase currents Iu, Iv, Iw, and sets the limitation rate L5c to 0%.

The current sensor abnormality detector 380 acquires the phase currents Iu, Iv, Iw detected by the current sensor 180. The cycle of acquiring the phase currents Iu, Iv, Iw, and the like is 1 ms, for example. The current sensor abnormality detector 380 calculates a limitation rate L5d of the phase currents Iu, Iv, Iw, too, by using the same linear pattern function graph as in FIG. 6. If the sum of the acquired phase currents Iu, Iv, Iw is not the threshold Ith (0[A]), the current sensor abnormality detector 380 determines that an abnormality occurs in the current sensor 180 and output of the motor 400 needs to be stopped immediately, and sets the limitation rate L5d to 0%.

The phase current protector 350 selects the minimum limitation rate from among the limitation rates L5a, L5b calculated by the overcurrent detector 360, the limitation rate L5c calculated by the current deviation detector 370, and the limitation rate L5d calculated by the current sensor abnormality detector 380. The selected limitation rate is output to the selector 390 as the limitation rate L5. If it is determined that the phase currents Iu, Iv, Iw, and the like are abnormal, the phase current protector 350 notifies the user of warning and failure information.

The overspeed protector 340 acquires the motor rotational speed ωe from the rotational speed calculator 230. The cycle of acquiring the motor rotational speed ωe, and the like is 1 ms, for example. The overspeed protector 340 calculates the limitation rate L4 of the acquired motor rotational speed ωe, too, by using the same linear pattern function graph as in FIG. 6. If the motor rotational speed ωe is equal to or higher than a threshold ωth, the overspeed protector 340 determines that the motor 400 overspeeds and output of the motor 400 needs to be stopped immediately, and therefore sets the limitation rate L4 to 0%. If it is determined that the motor rotational speed ωe is abnormal, the overspeed protector 340 notifies the user of warning and failure information. Note that the difference between the instruction rotational frequency ω* input by CAN communication and the motor rotational speed ωe may be used to calculate the limitation rate L4.

The selector 390 compares the limitation rate L1 from the DC current protector 310, the limitation rate L2 from the overvoltage-low-voltage protector 320, the limitation rate L3 from the overheat protector 330, the limitation rate L4 from the overspeed protector 340, and the limitation rate L5 from the phase current protector 350, and selects the minimum limitation rate Lmin of the limitation rates L1 to L5. The selected limitation rate Lmin is output to the torque controller 110. According to the example embodiment, since the minimum limitation rate Lmin is selected, torque can be controlled with the strictest limitation.

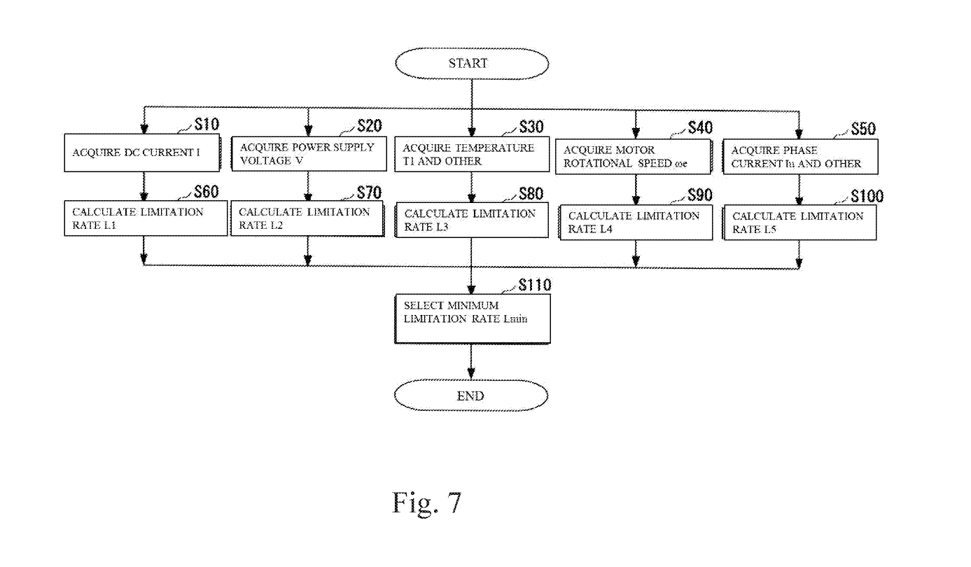

FIG. 7 is a flowchart showing an exemplar operation of the motor drive unit 100 to calculate the limitation rates L1 to L5 for limiting the instruction torque according to the traveling state of the vehicle.

As shown in FIG. 7, in step S10, the DC current protector 310 acquires the DC current I of the power source. In step S20, the overvoltage-low-voltage protector 320 acquires the power supply voltage V of the power source. In step S30, the overheat protector 330 acquires the temperature T1 of the motor 400, and the like. In step S40, the overspeed protector 340 acquires the motor rotational speed We of the motor 400. In step S50, the phase current protector 350 acquires the phase currents Iu, Iv, Iw flowing through the motor 400. Note that the steps S10 to S50 may be processed in parallel at the same time, for example.

Next, in step S60, the DC current protector 310 calculates the limitation rate L1 based on the acquired DC current I of the power source. In in step S70, the overvoltage-low-voltage protector 320 calculates the limitation rate L2 based on the acquired power supply voltage V of the power source. In step S80, the overheat protector 330 calculates the limitation rate L3 based on the acquired temperature T1 of the motor 400, and the like. In step S90, the overspeed protector 340 calculates the limitation rate L4 based on the acquired motor rotational speed ωe. In step S100, the phase current protector 350 calculates the limitation rate L5 based on the acquired phase currents Iu, Iv, Iw flowing through the motor 400. Note that the steps S60 to S100 may be processed in parallel at the same time.

Next, in step S110, the selector 390 selects the minimum limitation rate Lmin of the calculated limitation rates L1 to L5, and outputs the selected limitation rate Lmin to the torque controller 110. In the example embodiment, such processing is repeated at predetermined intervals.

As has been described, according to the example embodiment, multiple parameters such as the temperatures T1 to T3, the DC current I of the power source, the power supply voltage V, the motor rotational speed ωe, and the phase currents Iu, Iv, Iw are taken into account, and the limitation rate of the parameter having the highest level of abnormality among the parameters can be selected as the minimum limitation rate Lmin to limit the instruction torque Tq. Accordingly, even when the torque requires limitation that cannot be set by use of the conventional table storing torque upper limits, for example, the instruction torque can be limited optimally. As a result, overcurrent, overvoltage, overspeed, or temperature rise, for example, can be surely suppressed during operation of the motor 400.

Note that the technical scope of the present disclosure is not limited to the above example embodiment, and includes various modifications of the above example embodiment without departing from the gist of the present disclosure. Although the above example embodiment describes an example of using five limitation rates L1 to L5, the disclosure is not limited to this. For example, the instruction torque Tq may be limited by using limitation rates of at least two or more parameters. The temperature acquired by the limiting portion 300 may be at least one or more of the temperature T1 of the motor 400, temperature T2 of the switching element, and temperature T3 of the substrate, or may be temperatures related to other parts of the motor drive unit 100.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor drive, comprising:
limiting circuitry that controls a motor based on an instruction torque, and calculates a limitation rate that limits the instruction torque; and
a controller that limits the instruction torque based on the limitation rate calculated by the limiting circuitry, and outputs electric power to drive the motor based on the limited instruction torque.

2. The motor drive according to claim 1, wherein the limiting circuitry calculates a limitation rate of each of a plurality of input parameters, and selects a minimum limitation rate of the calculated limitation rates.

3. The motor drive according to claim 2, wherein the plurality of parameters include at least two or more of a direct current from a power source, a voltage of the power source, a temperature, a rotational frequency of the motor, and a current flowing through the motor.

4. The motor drive according to claim 3, wherein the temperature includes at least one or more of a temperature of the motor, a temperature of a switch provided in the motor drive, and a temperature of a substrate on which the switch is mounted.

5. The motor drive according to claim 3, wherein the limiting circuitry detects whether the motor exceeds a speed based on the rotational frequency of the motor.

6. The motor drive according to claim 3, wherein the limiting circuitry detects, based on the current flowing through the motor, at least one or more of an abnormality of a current sensor detecting the current, an abnormality of deviation between the current and a target current, and an overcurrent.
